(19) United States
(12) Patent Application Publication
(10) Pub. No.: US 2023/0163451 A1
(43) Pub. Date: May 25, 2023

(54) ATTACHMENT STRUCTURE FOR ANTENNA DEVICE

(71) Applicant: DENSO CORPORATION, Kariya-city (JP)

(72) Inventors: Toru KOIKE, Kariya-city (JP); Seishin MIKAMI, Kariya-city (JP)

(21) Appl. No.: 18/158,204

(22) Filed: Jan. 23, 2023

Related U.S. Application Data
(63) Continuation of application No. PCT/JP2021/024023, filed on Jun. 24, 2021.

(30) Foreign Application Priority Data
Jul. 30, 2020 (JP) 2020-129594

(51) Int. Cl. H01Q 1/32; H01Q 21/24; H01Q 1/42

(52) U.S. Cl. CPC H01Q 1/3275; H01Q 21/24; H01Q 1/42

(57) ABSTRACT

An attachment structure for an antenna device includes the antenna device attached to a vehicle. The antenna device includes an antenna element and a wire. The antenna element is arranged on a roof of the vehicle, and performs one or both of transmission and reception of a radio wave. The wire electrically connects the antenna element and a power supply unit provided inside the vehicle, and extends through a waterproof structure located between the roof and a member provided at a peripheral edge of the roof.

### CROSS REFERENCE TO RELATED APPLICATIONS

The present application is a continuation application of International Patent Application No. PCT/JP2021/024023 filed on Jun. 24, 2021, which designated the U.S. and claims the benefit of priority from Japanese Patent Application No. 2020-129594 filed on Jul. 30, 2020. The entire disclosure of all of the above applications are incorporated herein by reference.

### TECHNICAL FIELD

The present disclosure relates to an attachment structure for an antenna device attached to a vehicle.

### BACKGROUND

An antenna device with a shark fin shape arranged on a roof of a vehicle.

### SUMMARY

According to at least one embodiment, an attachment structure for an antenna device includes the antenna device attached to a vehicle. The antenna device includes an antenna element and a wire. The antenna element is arranged on a roof of the vehicle, and performs one or both of transmission and reception of a radio wave. The wire electrically connects the antenna element and a power supply unit provided inside the vehicle, and extends through a waterproof structure located between the roof and a member provided at a peripheral edge of the roof.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a front view of an antenna device according to a first embodiment.

FIG. 2 is a cross-sectional view illustrating the antenna device.

FIG. 3 is a diagram illustrating an attachment structure for the antenna device.

FIG. 4 is a diagram illustrating an attachment state of the antenna device.

FIG. 5 is a diagram illustrating the attachment state of the antenna device.

FIG. 6 is a cross-sectional view illustrating a sealing structure.

FIG. 7 is a cross-sectional view illustrating an attachment structure for an antenna device according to a second embodiment.

FIG. 8 is a cross-sectional view illustrating the antenna device.

### DETAILED DESCRIPTION

To begin with, examples of relevant techniques will be described. According to a comparative example, an antenna device with a shark fin shape arranged on a roof of a vehicle. In this antenna device, a circuit board of the antenna device arranged on the roof is electrically connected to an in-vehicle electronic device such as a communication device provided inside the vehicle via a signal cable extending through an opening provided on the roof.

Since the antenna device is provided on the roof, the opening is provided on the roof. Thus, a waterproof structure is required for the opening. Providing the opening on the roof can adversely affect rigidity of a vehicle body depending on a position and size of the opening, and thus, the opening may not be formed.

In contrast to the comparative example, according to an attachment structure for an antenna device of the present disclosure, the antenna device can be attached to a roof without providing an opening on the roof.

According to one aspect of the present disclosure, an attachment structure for an antenna device includes the antenna device attached to a vehicle. The antenna device includes an antenna element and a wire. The antenna element is arranged on a roof of the vehicle, and performs one or both of transmission and reception of a radio wave. The wire electrically connects the antenna element and a power supply unit provided inside the vehicle, and extends through a waterproof structure located between the roof and a member provided at a peripheral edge of the roof.

According to the attachment structure for the antenna device, the antenna element is arranged on the roof of the vehicle, and the wire electrically connects the antenna element and the power supply unit provided inside the vehicle. The wire extends through the waterproof structure located between the roof and the member provided at a peripheral edge of the roof. The member provided at the peripheral edge of the roof is, for example, a window, a spoiler, or a molded resin, and constitutes the vehicle. A waterproof structure ensures a waterproof property at a gap between the peripheral edge of the roof and the member. The waterproof property can be ensured by the waterproof structure through which the wire extends. As a result, the wire can be drawn into an interior of the vehicle from an upper side of the roof without an opening being formed on the roof for the wire. Therefore, the antenna element of the antenna device can be attached to the roof without providing an opening in the roof.

The following describes embodiments for carrying out the present disclosure with reference to the drawings. In each embodiment, a part corresponding to the part described in the preceding embodiment may be denoted by the same reference numeral or a reference numeral with one character added to a preceding reference numeral; thereby, redundant explanation may be omitted. In each embodiment, when only part of the configuration is described, the other part of the configuration can be the same as that in a preceding embodiment. The present disclosure is not limited to combinations of embodiments which combine parts that are explicitly described as being combinable. As long as no problems are present, the various embodiments may be partially combined with each other even if not explicitly described.

### First Embodiment

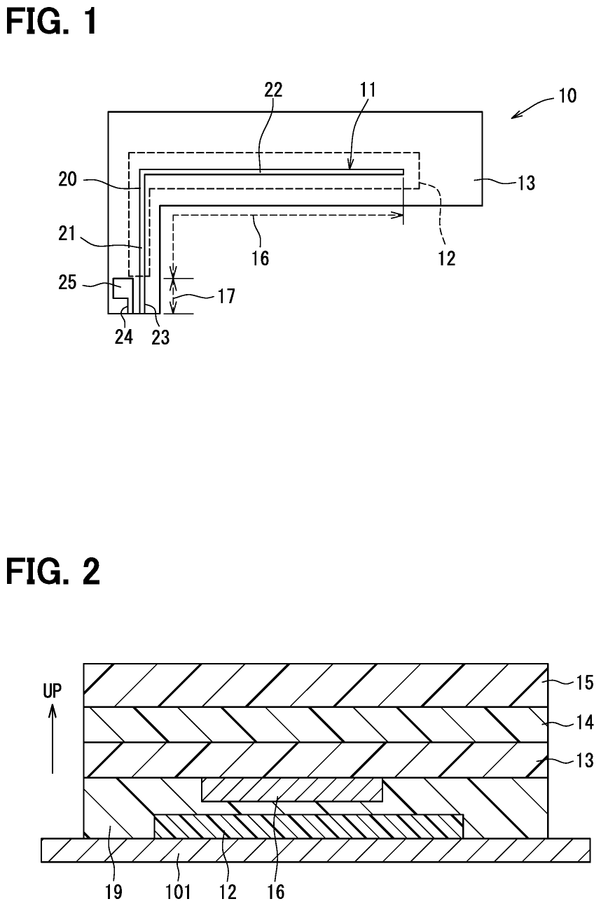

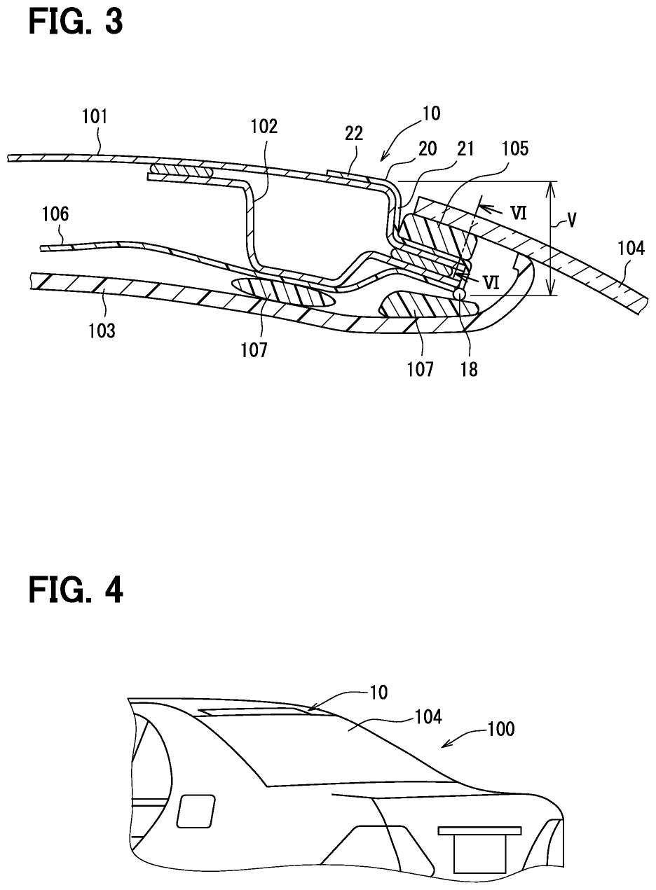

Hereinafter, a first embodiment of the present disclosure will be described with reference to FIGS. 1 to 6. An antenna device 10 has a substantially L-shape in a plan view as shown in FIG. 1. The antenna device 10 is arranged on a roof 101 of a vehicle 100 as shown in FIGS. 3 to 6. The roof 101 forms a ceiling of the vehicle 100, and is made of a flat metal plate in the present embodiment. In the present embodiment, the antenna device 10 has a thin film structure or a film structure and has electrical characteristics and flexibility, and is called a film antenna.

As shown in FIG. 3, a vehicle body frame 102 is provided under the roof 101 of the vehicle 100, that is, between the roof 101 and a vehicle compartment. The vehicle body frame 102 is a member that reinforces the roof 101. The vehicle body frame 102 also is a member that forms an outer frame of the vehicle 100 together with the roof 101. The vehicle body frame 102 is fixed to the roof 101 by mechanical connection, such as welding. A roof lining 103 that constitutes a ceiling of the vehicle compartment is provided under the vehicle body frame 102. There is a gap between the roof 101 and the roof lining 103.

The antenna device 10 includes an antenna element 11, a magnetic member 12, a base film 13, a decorative printed layer 14 and a topcoat layer 15. The antenna device 10 has a structure in which the antenna element 11 having a foil-like shape is provided on the base film 13 having a thin film shape.

The base film 13 has the thin film shape and an insulating property. The decorative printed layer 14 is provided on a surface of the base film 13 facing away from the vehicle 100, that is, facing upward in FIG. 2. The decorative printed layer 14 covers the base film 13. The decorative printed layer 14 is a decorative layer for protecting and decorating the antenna device 10, and is laminated on the base film 13 by printing, for example. The decorative layer is not limited to the decorative printed layer 14, and may be formed by laminating a decorative film.

The topcoat layer 15 is provided on a surface of the decorative printed layer 14 facing away from the vehicle 100, that is, facing upward in FIG. 2. The topcoat layer 15 is a protective film that protects an outermost surface of the antenna device 10. The topcoat layer 15 is formed by applying a coating material to the decorative printed layer 14, for example.

The antenna element 11 is laminated on the base film 13. The antenna element 11 is provided between the vehicle 100 and the base film 13, that is, downward of the base film 13 in FIG. 2. The antenna element 11 is realized, for example, by a conductive foil having a thickness of approximately 10 μm to 50 μm.

The conductive foil is formed of a conductive material, such as copper, having electrically conductivity. The conductive foil may have a flexible and bendable structure, and may be made of a foil-like material, or may be formed by, for example, electrolytic or electroless plating.

The antenna device 10 is fixed to the roof 101 by being attached to the roof 101 with an adhesive layer 19 made of an adhesive. The adhesive layer 19 is provided between the vehicle 100 and the base film 13 and between the vehicle 100 and the antenna element 11, that is, downward of the base film 13 and the antenna element 11 in FIG. 2.

The antenna element 11 includes a radiating portion 16 that constitutes an electrical wire and transmits and receives a radio wave, and feeder lines 23, 24 that are electrically connected to an in-vehicle electronic device such as a communication device. The antenna element 11 has a substantially L-shape as shown in FIG. 1. The antenna element 11 has a rod shape or a line shape.

The radiating portion 16 extends from a power supply unit 18 to a position on the roof 101. The power supply unit 18 is provided on the vehicle body frame 102 including a metal material. A length of the radiating portion 16 is set according to a wavelength A of the radio wave to be transmitted and received.

The radiating portion 16 does not function as an antenna if it is close to the vehicle body frame 102 and the roof 101. Thus, the radiating portion 16 includes the magnetic member 12 provided on a surface of the radiating portion 16 facing the roof 101. The magnetic member 12 separates the radiating portion 16 and the roof 101 in terms of high frequency. The magnetic member 12 is provided between the radiating portion 16 and the roof 101. The magnetic member 12 functions as a blocking member that blocks the radio-wave connection between the radiating portion 16 and the roof 101. The magnetic member 12 electromagnetically separates the radiating portion 16 and the roof 101. A shielding member is not limited to the magnetic member 12, and may be a radio wave absorber that absorbs the radio wave.

The radiating portion 16 has a vertical portion 21, a horizontal portion 22 and a connecting portion 20. The horizontal portion 22 of the radiating portion 16 extends in a left-right direction in FIG. 1 and is arranged on the roof 101. The horizontal portion 22 extends in a horizontal plane when the vehicle 100 is on the horizontal plane. The horizontal portion 22 mainly receives a horizontally polarized wave. Since the horizontal portion 22 extends on the roof 101, there is not radio wave shielding object, and the horizontal portion 22 is capable of transmitting and receiving the radio wave in 360-degree directions on the horizontal plane. A length of the horizontal portion 22 is preferably λ/4, for example. “λ/4” means the length of one quarter of the wavelength λ.

The vertical portion 21 of the radiating portion 16 is a part of a portion extending in an up-down direction of FIG. 1 and has a range indicated by an arrow V in FIG. 3. The connecting portion 20 connects the vertical portion 21 and the horizontal portion 22. The connecting portion 20 is a part of the portion extending in the up-down direction of FIG. 1. The connecting portion 20 connects a left end of the horizontal portion 22 and an upper end of the vertical portion 21 in FIG. 1.

The vertical portion 21 is bent in a direction tilted from an extending direction of the horizontal portion 22. The bending direction is tilted from a horizontal direction without being tilted in the horizontal plane. In the present embodiment, the vertical portion 21 is bent at two points into a Z shape along the roof 101. The vertical portion 21 extends through a waterproof structure located between the roof 101 and a rear window 104. A gap between the roof 101 and the rear window 104 is filled with a sealing structure 105 using sealing materials, thereby ensuring a waterproof property. When the roof 101 and the rear window 104 are arranged to cooperatively form an outer smooth peripheral surface of the vehicle 100 as shown in FIG. 3, the sealing structure 105 causes a height difference in the vertical portion 21 because the rear window 104 is thicker. At least a portion of the vertical portion 21 having this height difference extends in a vertical direction when the vehicle 100 is on the horizontal plane, and receives horizontally polarized waves well.

A part of the vertical portion 21 extending through the sealing structure 105 of the rear window 104 is installed at a vertical angle or an angle suitable for transmission and reception of the vertically polarized wave. The length in the vertical direction indicated by the arrow V in FIG. 3 may be set larger than a tenth of the wavelength A of transmission and reception.

As shown in FIG. 1, a wire 17 includes a signal feeder line 23 and a ground feeder line 24. The signal feeder line 23 is connected to the antenna element 11. The ground feeder line 24 includes a ground connecting portion 25 at one end of the ground feeder line 24. The ground connecting portion 25 is connected to the power supply unit 18 of the vehicle body frame 102. The other end of the ground feeder line 24 is connected to the in-vehicle electronic device. One end of the signal feeder line 23 is connected to the antenna element 11, and the other end of the signal feeder line 23 is connected to the in-vehicle electronic device.

The ground connecting portion 25 is arranged adjacent to the signal feeder line 23, as shown in FIG. 1. In addition, FIG. 3 shows a relationship between the vehicle body frame 102 and the power supply unit 18. A coating film of the vehicle body frame 102 and the base film 13 are provided between the ground connecting portion 25 and the power supply unit 18. Thus, the ground connecting portion 25 is arranged adjacent to the power supply unit 18 of the vehicle body frame 102. As a result, the ground connecting portion 25 and the power supply unit 18 form high-frequency capacitive coupling. The ground connecting portion 25 provides a ground potential by arranging adjacent to the power supply unit 18 of the vehicle body frame 102. The antenna device 10 is connected to the in-vehicle electronic device via a coaxial cable 106. An inner conductor of the coaxial cable 106 is connected to the signal feeder line 23. An outer conductor of the coaxial cable 106 is connected to the ground feeder line 24.

In the present embodiment, the ground potential of the ground connecting portion 25 is coupled with the vehicle body frame 102 by the high-frequency capacitive coupling. Alternatively, a metal of the vehicle body frame 102 and the ground connecting portion 25 may be directly electrically connected. An elastic member 107 is provided below the ground connecting portion 25. The gap between the ground connecting portion 25 and the roof lining 103 is filled with the elastic member. The elastic member 107 stably supports the ground connecting portion 25 and the power supply unit 18 of the vehicle body frame 102.

Further, the power supply unit 18 on the vehicle body frame 102 is arranged at a position so as not to face the vertical portion 21 in the vertical direction. More specifically, as shown in FIG. 3, the power supply unit 18 is provided at a lower end portion of the vertical portion 21 where the antenna element 11 is bent frontward in a vehicle front-rear direction. If the power supply unit 18 is shifted from the position in the vehicle frontward direction, that is, in a leftward direction of FIG. 3, the power supply unit 18 and the vertical portion 21 face each other in the vertical direction. In this case, current directions are opposite between the vertical portion 21 and the power supply unit 18, and an electric field may be canceled, resulting in decrease in signal strength. Therefore, as in the present embodiment, the power supply unit 18 is provided rearward of a part of the bent vertical portion 21 in the vehicle front-rear direction.

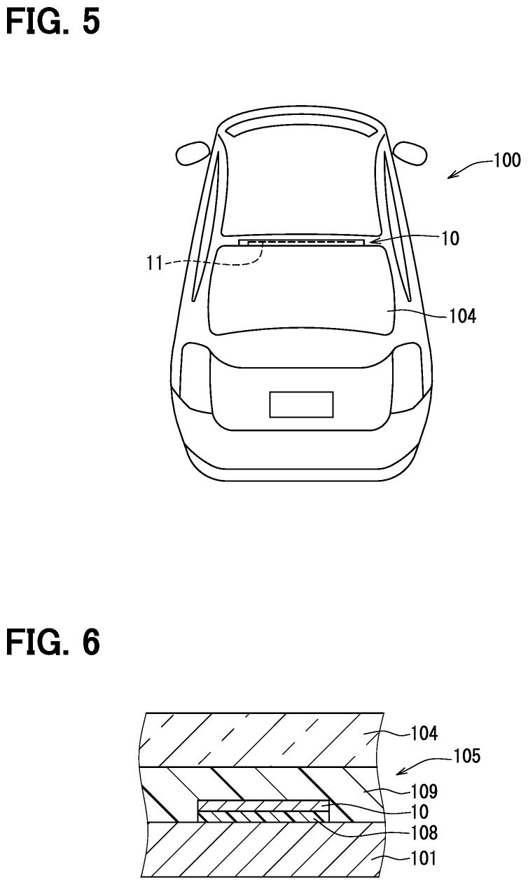

As shown in FIGS. 4 and 5, the antenna device 10, as described above, extends from an upper surface of the roof 101 through the sealing structure 105 of the rear window 104 to the vehicle compartment, specifically, to the roof lining 103. FIG. 6 shows a cross-sectional view illustrating the sealing structure 105, and the sealing materials 108,109 are provided on both surfaces of the antenna device 10. More specifically, a first sealing material 108 is provided between the antenna device 10 and a sealing surface of the roof 101 to ensure the waterproof property and a dustproof property. A second sealing material 109 is provided between the rear window 104 and the antenna device 10 and between the rear window 104 and the sealing surface of the roof 101 to ensure the waterproof property and the dustproof property. The second sealing material 109 is for fixing the rear window 104, and the rear window 104 is attached to the roof 101 via the second sealing material 109. Thus, it is possible to ensure the waterproof property and the dustproof property in a portion extending through the sealing structure 105 of the antenna device 10.

As described above, according to the attachment structure for the antenna device 10 of the present embodiment, the antenna element 11 is arranged on the roof 101 of the vehicle 100, and the wire 17 electrically connects the antenna element 11 and the power supply unit 18 provided inside the vehicle 100. The wire 17 extends through the waterproof structure located between the roof 101 and the member provided at a peripheral edge of the roof 101. The member that is, for example, a window, a spoiler, or a molded resin, is attached to the peripheral edge of the roof 101, thereby constituting the vehicle 100. The waterproof property can be ensured by the waterproof structure through which the wire 17 extends, since the waterproof structure is located between the peripheral edge of the roof 101 and the member. As a result, the wire 17 can be drawn into an interior of the vehicle 100 from an upper side of the roof 101 without an opening formed on the roof 101 for the wire 17. Therefore, the antenna element 11 of the antenna device 10 can be attached to the roof 101 without providing an opening in the roof 101.

Further, in the present embodiment, the wire 17 extends through the sealing structure 105 between the roof 101 and the window of the vehicle 100, specifically, the rear window 104. The window of the vehicle 100 is attached to the roof 101 using the second sealing material 109. Since the wire extends through the second sealing material 109, the waterproof property can be ensured by the second sealing material 109. In addition, the attachment structure can be realized by installing the antenna device 10 and extending the wire in advance in the same window attachment process as in an existing vehicle 100.

Furthermore, in the present embodiment, the antenna element 11 has the horizontal portion 22 and the vertical portion 21. The horizontal portion 22 functions as a first antenna element that extends on the roof 101 and mainly receives the horizontally polarized wave. The vertical portion 21 has a part that extends through the waterproof structure in the extending direction tilted from a direction in which the horizontal portion 22 extends. The vertical portion 21 functions as a second antenna element that mainly receives the vertically polarized wave. The vertical portion 21 extending through the sealing structure 105 of the rear window 104 tilts from the horizontal portion 22, and can be set at an angle so as to easily receive the vertically polarized wave. By adopting this structure, the antenna element 11 can be extended on the roof 101 without making an opening in the roof 101, and further, the vertically polarized wave can be transmitted and received, and an attachment structure for the antenna device 10 having a flat structure on the roof 101 can be provided.

Further, in the present embodiment, the magnetic member 12 is provided between the antenna element 11 and the roof 101, and blocks the radio-wave connection between the antenna element 11 and the roof 101. Thus, even if the roof 101 is made of metal, it is possible to realize the antenna device 10 that transmits and receives the radio wave while reducing an influence of the roof 101.

Furthermore, in the present embodiment, the antenna device 10 further includes the decorative printed layer 14 provided outside the antenna element 11 and decorating the antenna element 11. Although the roof 101 forms an appearance of the vehicle 100, deterioration in visual appearance of the antenna device 10 can be reduced by the decorative printed layer 14.

In the present embodiment, the antenna device 10 has the ground connecting portion 25 in which a foil-like radiating portion 16 is provided on the thin base film 13. The ground connecting portion 25 is arranged adjacent to the vehicle body frame 102 in the vehicle compartment. Then, a tip end of the radiating portion 16 is arranged on the roof 101 outside the vehicle compartment. The wire extends through the sealing structure 105 between the rear window 104 and the roof 101, while the sealing structure can be ensured the waterproof property and the dustproof property.

As a result, the antenna device in the present embodiment is not an antenna device with a shark fin shape arranged on a roof of a vehicle. Thus, since the antenna device does not have a shape which protrudes upward from the roof 101, deterioration in visual appearance of the vehicle 100 can be reduced. Moreover, since the sealing structure 105 also ensures the waterproof property, a waterproof structure dedicated to the wire of the antenna device 10 and its parts are not required, and the wire can be drawn into the vehicle 100 without providing an opening on the roof 101.

Furthermore, since the antenna element 11 is installed on the roof 101, there is not radio wave shielding object in 360-degrees on the horizontal plane, so a gain can be obtained by the antenna element in all directions. Therefore, the degree of freedom in installing the antenna element 11 can be improved.

### Second Embodiment

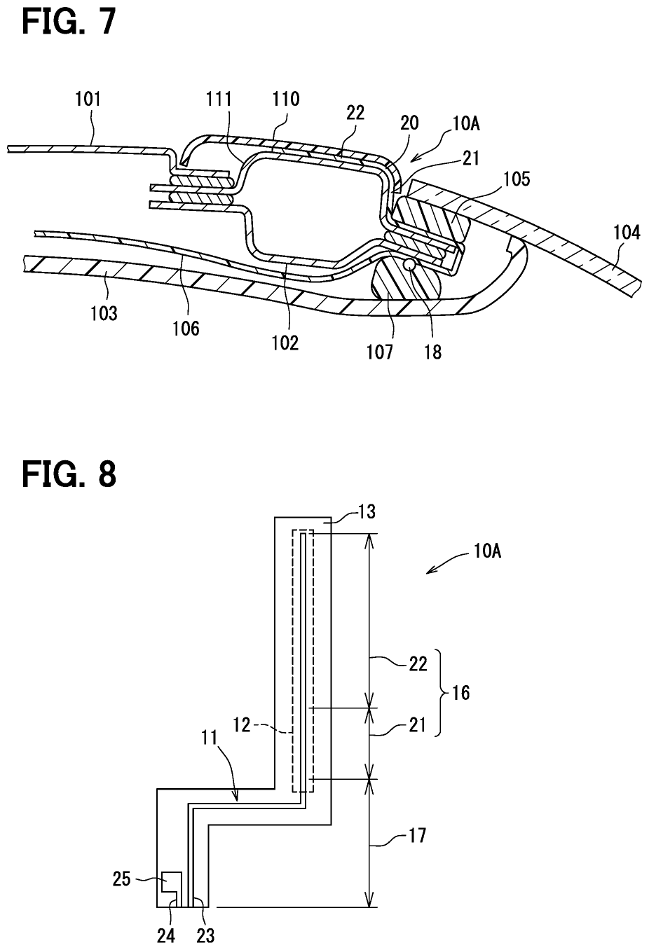

Next, a second embodiment of the present disclosure will be described with reference to FIGS. 7 and 8. The second embodiment is characterized in that an antenna device 10A further includes a resin member 110 covering an outside of an antenna element 11. Moreover, a configuration of the antenna element 11 and an arrangement of a power supply unit 18 of the present embodiment are different from those of the above-described first embodiment.

In the present embodiment, a roof 101 includes a frame member 111, as shown in FIG. 7. The frame member 111 is a part of a vehicle body frame 102. In other words, the part of the vehicle body frame 102 is not covered with the roof 101, and the part of the vehicle body frame 102 is exposed to an outside.

In the present embodiment, as shown in FIG. 7, the frame member 111 is provided at a rear end of the roof 101 instead of a rear window 104. A connecting portion 20 between the roof 101 and the frame member 111 is joined by welding to form a waterproof structure. A space between the frame member 111 and the rear window 104 is filled with a sealing structure 105 using sealing materials 108, 109, thereby providing a waterproof property.

The antenna device 10A is arranged on the frame member 111 as shown in FIG. 7. The frame member 111 is covered with the resin member 110. Therefore, the antenna device 10A is arranged between the frame member 111 and the resin member 110. The resin member 110 is a decorative part that includes a resin material and forms an outer shape of a vehicle 100. The resin member 110 is realized by, for example, a molded resin and a spoiler. Since the antenna device 10A is covered with the resin member 110, no decorative surface is required.

The antenna element 11 has a substantially N-shape as shown in FIG. 8. As shown in FIG. 8, a radiating portion 16 of the antenna element 11 has a straight shape in which a vertical portion 21 and a horizontal portion 22 are continuous. The horizontal portion 22 of the radiating portion 16 is a part of a portion extending in an up-down direction in FIG. 8 and arranged on the roof 101. The vertical portion 21 of the radiating portion 16 is another part of the portion extending in the up-down direction in FIG. 8, similar to the horizontal portion 22. In other words, the horizontal portion 22 of the present embodiment is different from the horizontal portion 22 of the first embodiment in extending direction.

As shown in FIG. 8, a wire 17 has an L-shape and is continuous with an !-shape of the radiating portion 16. A ground connecting portion 25 of the wire 17 is arranged apart from the radiating portion 16 in a left-right direction in FIG. 8. As shown in FIG. 7, the ground connecting portion 25 appears to face the vertical portion 21 in the vertical direction. However, since the ground connecting portion 25 is arranged apart from the radiating portion 16 in the horizontal direction as described above, the ground connecting portion 25 is not arranged so as to face the vertical portion 21 and is shifted from the vertical portion 21 in a horizontal direction when the vehicle 100 is viewed in the vertical direction.

As shown in FIG. 7, the power supply unit 18 is provided frontward of a bent part of the lower end portion of the vertical portion 21 where the antenna element 11 is bent frontward in a vehicle front-rear direction. Thus, since the ground connecting portion 25 is arranged adjacent to a flat portion of the vehicle body frame 102, the ground potential can be provided more reliably.

In the present embodiment, the antenna device 10A further includes the resin member 110 covering an outside of the antenna element 11. Thus, in the antenna device 10A, no decorative layer is required. The configuration of the antenna device 10A can be simplified.

### Other Embodiments

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the above-described first embodiment, the roof 101 includes a metal plate, but the configuration is not limited to this. If the roof 101 of the vehicle 100 is made of a nonmetallic material such as a resin, the shielding member arranged on the vehicle surface of the radiating portion 16 is not necessary.

In the above-described first embodiment, the number of the antenna element 11 is one, but the number is not limited to one, and may be two or more. For example, the antenna device 10 may have two antenna elements 11, one of the two antenna elements 11 may serve as a so-called main antenna for receiving the horizontally polarized wave, and the other may serve as a sub-antenna for receiving the vertically polarized wave. The antenna element 11 may also have other shapes, such as a loop antenna.

In the above-described first embodiment, the waterproof structure is the sealing structure 105, but the configuration is not limited to such structure. For example, the waterproof structure may be a labyrinth structure, a fitting structure, and a waterproof structure using other members such as a waterproof packing.

In the above-described first embodiment, the sealing structure 105 is arranged between the roof 101 and the rear window 104, but the sealing structure 105 is not limited to the rear window 104. For example, the sealing structure 105 may be arranged between the roof 101 and a fixed window that does not have an opening/closing mechanism, and the fixed window may be a front window or a sunroof.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

1. An attachment structure for an antenna device, the attachment structure comprising the antenna device attached to a vehicle, wherein
the antenna device includes:
an antenna element arranged on a roof of the vehicle, and configured to perform one or both of transmission and reception of a radio wave; and
a wire electrically connecting the antenna element and a power supply unit provided inside the vehicle, and extending through a waterproof structure located between the roof and a member provided at a peripheral edge of the roof.

2. The attachment structure according to claim 1, wherein
the member is a window of the vehicle, and
the waterproof structure is a sealing structure including a sealing material provided between the roof and the window.

3. The attachment structure according to claim 1, wherein
the antenna element includes
a first antenna element extending on the roof, and configured to mainly receive a horizontally polarized wave, and
a second antenna element extending through the waterproof structure in a direction tilted from an extending direction of the first antenna element, and configured to mainly receive a vertically polarized wave.

4. The attachment structure according to claim 3, wherein
the first antenna element and the second antenna element are integrally formed.

5. The attachment structure according to claim 1, wherein
the roof includes a metal plate, and
the antenna device further includes a blocking member provided between the antenna element and the roof, and configured to block a radio-wave connection between the antenna element and the roof.

6. The attachment structure according to claim 1, wherein
the antenna device further includes a decorative layer provided outside the antenna element, and protecting the antenna element.

7. The attachment structure according to claim 1, further comprising
a resin member covering an outside of the antenna element.

8. The attachment structure according to claim 1 wherein
the power supply unit is arranged at a position different in a horizontal direction from a position of a part of the antenna element extending through the waterproof structure when the antenna device is viewed in a vertical direction.
